(19) United States
(12) Patent Application Publication
(10) Pub. No.: US 2008/0283564 A1
(43) Pub. Date: Nov. 20, 2008

(54) Cargo or luggage basket rack for a vehicle

(76) Inventor: Scot Hogan Dinsmore, Petaluma, CA (US)

Correspondence Address: SCOTT DINSMORE, 422 WALNUT STREET, PETALUMA, CA, 94952, US

(21) Appl. No.: 11/804,881

(22) Filed: May 19, 2007

(51) Int. Cl. B60R 9/00

(52) U.S. Cl. 224/319; 224/309

(57) ABSTRACT

This describes a cargo or luggage carrying basket assembly which attaches to an existing rack assembly on a vehicle roof. The existing rack assembly consists of two bar frame assemblies with coupling to attach to the car roof. The main difference in configuration is whether the bars or rack assemblies run perpendicular to the main longitudinal axis of the car (one side of the car the other) or parallel to it. (Front of car to back of car) This invention can attach itself to either of the above described configurations. The basket consists of pipe sections and fittings made of tubular, hollow plastic pipe with certain members reinforced with wire. The primary use of this invention is for luggage and material normally stored in a vehicle trunk. It is not intended to allow the mounting of other sports equipment to the underlying, existing load bars or rack assembly. This invention can hold sports equipment if the sports equipment fits into the basket and is properly secured however this invention's use is not designed to hold sports equipment such as snow skis, snowboards and adult size bicycles. This invention is designed to attach to nearly all existing rack systems and is not designed to attach directly to the roof. One of this invention's primary improvements is the use of plastic pipe and other manufactured products to reduce the cost to make one compared to other similar inventions. As well no additional skill such as welding is needed to construct this device.

### CROSS REFERENCE TO RELATED APPLICATION

This application claims the benefit of earlier filed provisional application 60/747,961.

The present invention relates to an equipment or luggage rack which mounts to the top of a vehicle. In particular, this invention provides a cargo or luggage basket made of plastic pipe and fittings reinforced with an inner skeleton of wire in the outermost members. By using plastic pipe and with no chemical adhesive to connect the joints, the skill level to make it is greatly reduced compared to other similar inventions.

### BACKGROUND OF THE INVENTION

More and more vehicles have or come from the manufacturer with some sort of rack assembly on their hood. The typical scenario is a base rack assembly consisting of 2 load bars mounted to the roof of a vehicle. On top of the base assembly can be attached several different types of assemblies. To these additional assemblies, can be attached bicycles, skis or snowboards and kayaks. These inventions involve objects or devices made of coated or painted metal formed into appropriate shapes and configurations to hold the desired sports equipment. The coating or paint is applied to prevent oxidation.

One of these assemblies is a cargo basket or rack. Most cargo racks effectively have some sort of lip or edge bar or member to keep cargo in. As well, they maybe adjustable, allow for add on segments or the attachment of sports equipment to the underlying rack assemblies. The versatility of such assemblies and the use of steel or other materials allows for a wide variety of configurations. There are many variations and they generally fall into 2 categories. One general type does not attach to the vehicle surface itself but to an underlying rack which attaches to the vehicle surface. The other general type attaches to the vehicle surface itself either permanently with penetrations of the vehicle surface or temporarily attaches to the vehicle surface with straps or hooks.

### SUMMARY OF THE INVENTION

This present invention describes a large, light weight basket rack assembly made of plastic pipe for the holding of luggage or cargo. It does not allow for the attachment of sports equipment onto the underlying rack assembly and it is not adjustable. This present invention positively addresses the issues of ease and cost of constructability, weight and size with the use of manufactured hollow, tubular plastic pipe and fittings. This allows for manual rack assembly without any training such as welding, resulting in lower costs. By using plastic pipe, a large basket/cargo rack can be constructed, as large as most racks currently available however but one that is lightweight making for a more temporary “as-needed” vehicle rack that can be put on and removed more easily than similar inventions.

This current invention is also presented because of the current and realistically future gasoline (fuel) situation. Whatever future fuel process is predominantly used for automobiles, automobile design could embody very small, ultra-fuel efficient vehicles. Because of their reduced size, inside storage space may be limited and all vehicles may have a built-in rack or allowance for adding a rack. Light weight yet large cargo racks might be a well needed extra. This present invention does not however address the issue of fuel efficiency in of itself because it does rest on top of an existing vehicle (and rack) and will negatively impact vehicle fuel efficiency due to diminished aerodynamics of the vehicle. Fuel efficiency of the vehicle should be of such a high level which may be the case in the future as to not be severely effected by this type of luggage or cargo rack.

### BRIEF DESCRIPTION OF DRAWINGS

FIG. 1 is an isometric view of the cargo/luggage rack

FIG. 2 is an enlarged view taken from the area defined by line 2 in FIG. 1

FIG. 3 is a sectional view taken along line 3-3 of FIG. 2.

FIG. 4 is a sectional view taken along line 4-4 of FIG. 2.

FIG. 5 is a an isometric view showing which members have wire reinforcing

### DESCRIPTION OF THE PREFERRED EMBODIMENT

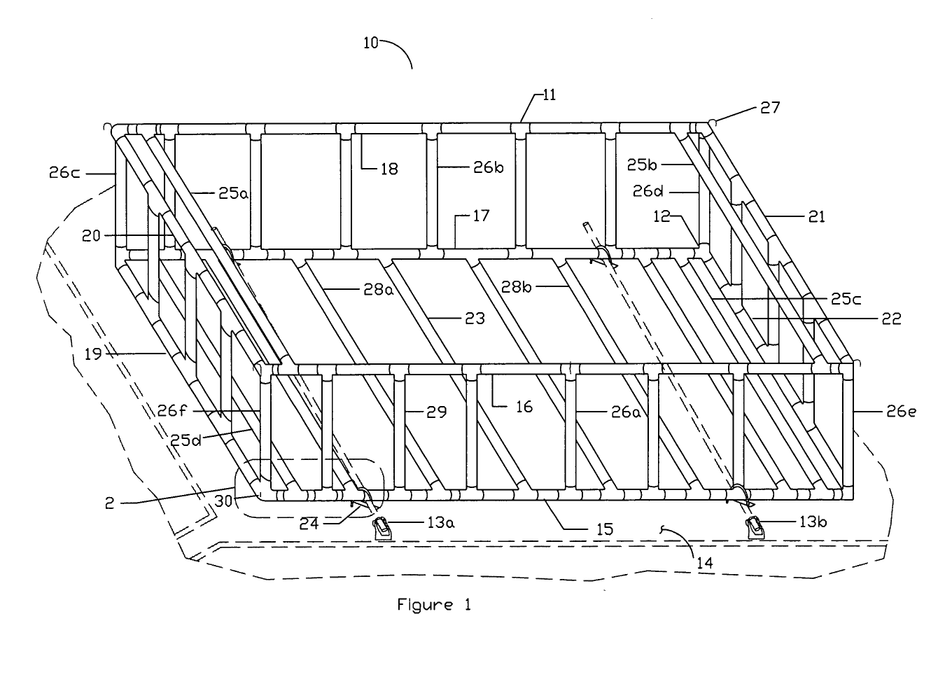

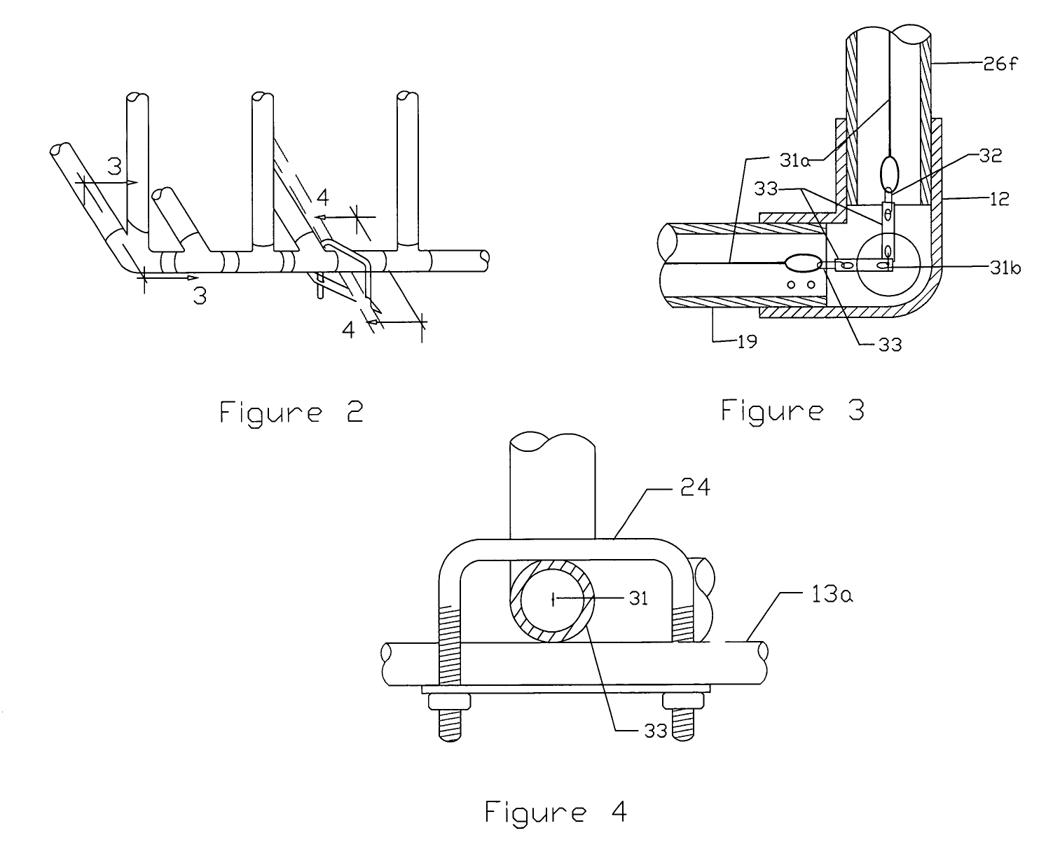

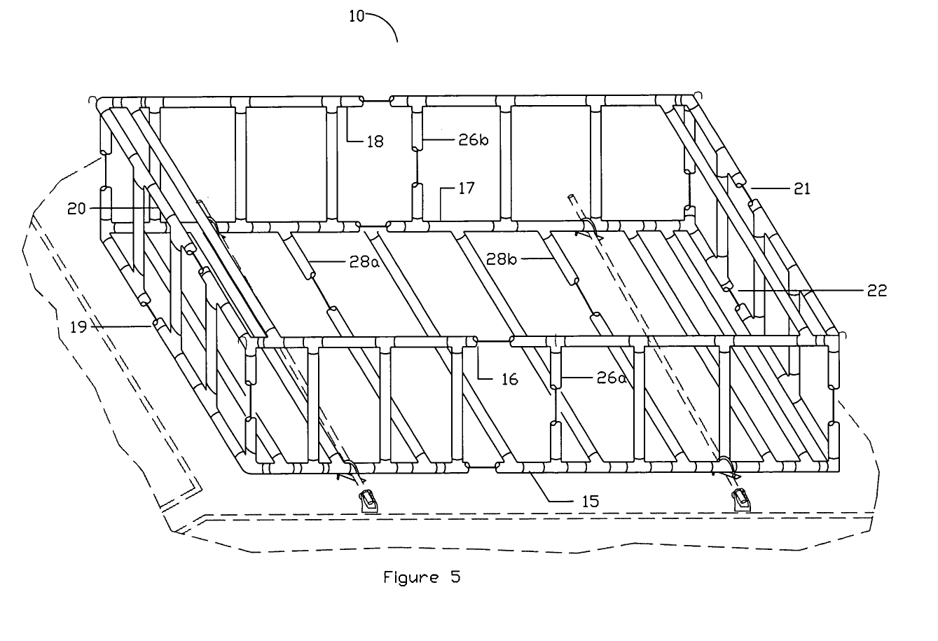

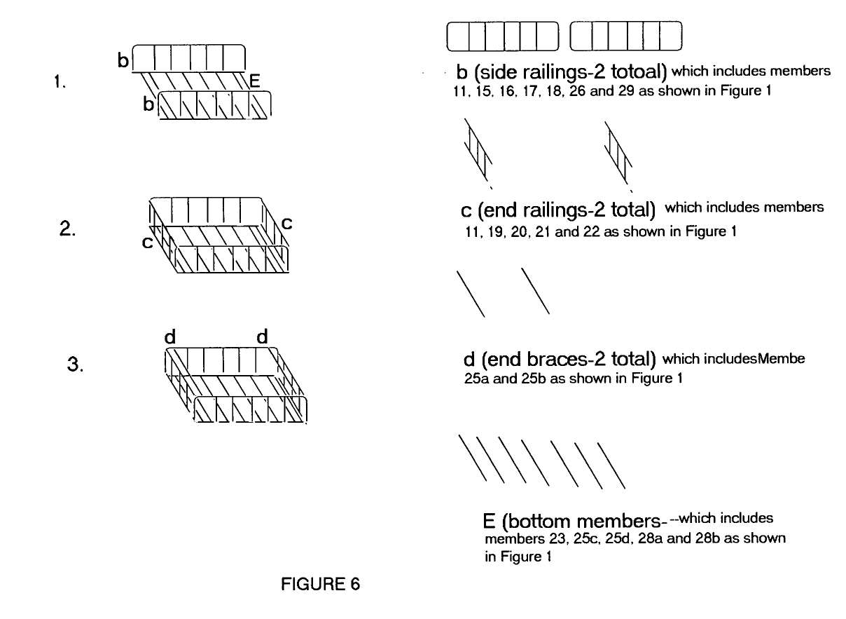

This invention provides a cargo or luggage rack in the form of an open topped box made of tubular, hollow plastic pipe. The invention is shown as Rack 10 in FIG. 1. Connector 11 is a slip fit Tee plastic pipe fitting which is used throughout the rack except at the eight corners where connector 12 is a slip fit side outlet 90 degree fitting. Chemical adhesive is not used to connect the fittings and pipe sections together. By not using chemical adhesive, adjustments to the alignment of fittings and pipe sections can be made while assembling a rack. Instead the frame has flexibility and ease of construction with the plastic pipe joints unglued while internal wire cable inside a portion of the individual members helps to maintain the integrity of the frame once it is in use. FIG. 5 shows Rack 10 and visually indicates which of the individual members has wire reinforcing. As well as the wire reinforcing, there is sliding friction of the unglued plastic pipe connection itself however the coefficient of sliding friction is believed to lessen with time and usage of the fittings. By using plastic pipe, corrosion is not an issue and the cargo rack is lightweight. The invention is painted but only for esthetics. And multiple colors maybe used if so desired. Black is the base color and it is applied in a 2 step process. A black colored paint-on-plastic adhesion promoter is first applied and then a glossy black oil based paint. Both coatings are applied by dipping partially assembled portions of the invention.

FIG. 1 shows the invention in a typical configuration. Rack 10 is attached to a pair of crossbars 13a and 13b which are mounted to vehicle roof 14 and are not part of this invention. A standard U joint, connector 24, attaches Rack 10 to crossbars 13a and 13b at 4 locations. The shape of Rack 10 is that of a rectangular open topped box with the outermost frame members connected with internal wire cable. Members with wire reinforcing include side members 15, 16, 17 and 18, end members 19, 20, 21 and 22 and corner side members 26c, 26d, 26e and 26f. The side structure generally runs from the front to the rear of the car. Side structure 15, 16, 17 and 18 define the sides of the rack. Rack 10 also includes front and back structures 19, 20, 21 and 22. A floor structure formed of horizontal members 23 extends from side members 15 and 17. A side structure formed of vertical members 29 extends on all 4 sides of the frame from bottom and top members 15 and 16, 19 and 20, 17 and 18, and 21 and 22. To give additional strength and redundancy to the frame, there is wire reinforcing in bottom and side members 26a, 26b, 28a and 28b. As well, members 25a, 25b, 25c and 25d are included to add rigidity and torsional resistance. The wire used is generic wound or wrapped 6 wire cable with a capacity of 120 pounds but any similar material could be used. At the top corners and approximately midway along members 16 and 18 at the top of members 26a and 26b, optional rope hook 27 is attached with bolts penetrating the plastic fitting.

FIG. 3 shows the inside of a corner connector 12. The wire reinforcing 31 from three different members is connected with connectors 32 and 33. Connector 32 is a quick link, eyehook or plastic cable-tie. The connection at this point should be small enough to fit inside the plastic pipe and strong enough to transfer loads to the wire. In FIG. 3, wire 31b shown in section, continues through the corner connector 12 and would connect to washer 30. (Not shown here) The wire 31 inside vertical members 26c, 26d, 26e, 26f and end members 19, 20, 21 and 22 attaches to the wire inside members 15, 16, 17 and 18 so that the internal wire framework is interconnected.

FIG. 4 shows a U joint connector 24 which attaches this invention to an existing rack assembly 13a. Internal wire 31 is shown in section. The size and configuration of the invention and underlying rack assembly must be such that side bottom members 15 and 17 can be clamped with the U-Joint to the underlying rack assembly.

FIG. 6 shows the partially assembled rack as it might be shipped and refers to the members called out in FIG. 1 as they could be assembled and shipped.

What is claimed is:

1. A cargo or luggage basket rack constructed of manufactured materials such as plastic pipe, plastic pipe fittings, metal U-bolt connections, wire or cable and cable ties or metal eyehooks that already exist and be assembled with manual labor only and no additional skills such as welding.

2. The use of hollow, tubular plastic pipe with an internal skeleton of a different material such as wire, cable or threaded rod for additional strength and overall stability to produce a cargo or luggage basket rack of claim 1 at a lower cost than other similar inventions.

3. The use of a manufactured connection such as a U-bolt or similar connector of sufficient strength that already exists and can be purchased to attach the invention of claim 1 to an existing vehicle rack on which the cargo or luggage basket rack of claim 1 would sit and be connected to.

4. The cargo or luggage basket rack of claim 1 would be partially assembled to keep shipping costs low to someone not familiar with the art that could complete assembly with manual labor only and no additional skills such as welding.

5. Use of tubular, hollow plastic pipe and fittings with a internal skeleton of wrapped wire, cable or threaded rod in such a fashion to construct the cargo or luggage backset rack of claim 1 in the shape of an open top box with 4 generally perpendicular sides that can be constructed without the use of welding or chemical glues.

6. The cargo or luggage basket rack of claim 1 would not connect to the vehicle roof itself but would sit on and connect to any existing vehicle rack assembly or structure that provides a generally level surface of connection points to its structure for the purpose of storing luggage or material typically placed in a vehicle trunk and would not allow for the attachment of sports equipment onto itself or the underlying existing rack structure.
